(19) United States
(12) Patent Application Publication
(10) Pub. No.: US 2017/0043193 A1
(43) Pub. Date: Feb. 16, 2017

(54) Lens Frame Lock WM

(71) Applicant: William J. Mike, Ketchikan, AK (US)

(72) Inventor: William J. Mike, Ketchikan, AK (US)

(21) Appl. No.: 14/825,514

(22) Filed: Aug. 13, 2015

(51) Int. Cl. A62B 18/08; A62B 18/02; A62B 7/00

(52) U.S. Cl. CPC A62B 18/082; A62B 7/00; A62B 18/02

(57) ABSTRACT

A respirator full face mask formed from plastic and aluminum with a multi-compound curved face seal having a superior configuration for facial fit. The present invention is also directed to provide a full face respirator as a protective device can be used in construction field, painting, asbestos handling, working in tanks, confined spaces and any type of work where a person needs to keep hazardous materials or particulates out of their respiratory system. The device of this invention includes a picatinny style clamp and rail to join together the two halves of the lens frames to the rest of the respirator.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

Field of the Invention

The present invention relates to a respirator and, more particularly, to a full face respirator which works by using a picatinny style clamp and rail to join together.

Background of the Invention

Respirators providing for a breathable air supply to a wearer are well known and have been used for many years. Such masks are used by firefighters, in the military, and industries where the air supply may be contaminated. In addition to providing a clean air source to the nose and mouth for breathing, full face shields also provide a seal to protect the eyes and face from harmful or irritating gases and other substances. Such masks typically include a transparent face shield and may also include mounts for accepting detachable and replaceable filter elements or connectors to air supplies. Such mounts often are threaded connectors that require considerable time and effort to attach and detach and do not provide a stop at a positive locking position.

The respirators can be used during fires, military operations, and hazardous industrial applications where the air supply may be contaminated. In addition to providing a clean air source to the nose and mouth for breathing, full-face respirators also protect the eyes and face from harmful or irritating gases and other substances. The devices can further include mounts for accepting detachable and replaceable filter elements or connectors to air supplies.

U.S. Pat. No. 5,714,126. Due to their rigid shell design, such filter cartridges are inflexible, and if they are thick enough, they sometimes make it difficult for the user to wear certain eye and face protection such as a welding hood.

U.S. Pat. No. Re. 35,062 shows a flexible particulate filter having front and back walls of filter material joined to each other along their peripheral edges in a spaced-apart relationship and equipped with a breather tube having an attachment means to secure the filter to a respirator mask.

An example of a full face respirator mask is North Safety Equipment's Model 7600 series respirator. The full face piece of North has orifices formed there through for receiving breathable air. The orifices, however, require the attachment of separate mounting hardware mechanically attached to the face piece for connecting to a breathable air source. The North face piece requires a separate cartridge connector and a grommet mounting to the face piece for mating to a connector of a breathable air source. If the connector pieces are not properly tightened, the mask may leak or the connector assembly may rotate in the orifice. Some filter cartridges are oriented to a specific position and may become misaligned should they rotate, possibly impairing the wearer's visual field.

There are a number of specific types of respirators in common use. These respirators include a lens, a face seal for mounting the lens about the face of a wearer, and one or more ports for providing an air supply to the wearer's face. Ports are provided in the face seal attached to the lens or in the lens material itself These ports add complexity and cost to processes for making the face seal and/or lens. Additionally, respirators can be configured for different modes depending on particular situations for use. However, configuring respirators for multiple situations can lead to design tradeoffs that make the respirators less than optimal.

### SUMMARY OF THE INVENTION

The present invention is provide a full face respirator as a protective device can be used in construction field, painting, asbestos handling, working in tanks, confined spaces and any type of work where a person needs to keep hazardous materials or particulates out of their respiratory system.

The device of this invention includes a picatinny style clamp and rail to join together the two halves of the lens frames to the rest of the respirator. This design has a swivel on the picatinny style clamp that is attached to the lens frame. Therefore ending up with no loose pieces of the lens frame assembly.

As described above, the functional aspects of the present invention is eliminating the miniscule nut and bolt. The preferred material is used in the invention is plastic and aluminum.

The main advantage of the present invention is that it can be used in all environments.

Other features and advantages of the present invention will become more apparent from the following detailed description, taken in conjunction with the accompanying drawings which illustrate, by way of example, the principles of the invention.

### BRIEF DESCRIPTION OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 is a diagram illustrating the full face respirator to keep hazardous materials or particulates out of their respiratory system.

FIG. 2 depicts the clamp and rail are picatinny style clamp and rail.

### DETAILED DESCRIPTION OF THE INVENTION

The following detailed description refers to the accompanying drawings that illustrate the embodiments of the present invention. Other embodiments are possible and modifications may be made to the embodiments without departing from the spirit and scope of the invention. Therefore, the following detailed description is not meant to limit the invention. Rather the scope of the invention is defined by the appended claims.

A respirator is a device designed to protect the wearer from inhaling harmful dusts, fumes, vapors, or gases. Respirators come in a wide range of types and sizes used by the military, private industry, and the public. Respirator ranges from cheaper, single-use, disposable masks to reusable models with replaceable cartridges. A respirator does not perform any actual breathing function for its wearer. Instead, its purpose is to purify inhaled air before it enters the lungs by trapping harmful particles and fumes. A respirator usually takes the form of a partial or full face-mask that is secured in place with a strap. Its purification function is performed by a filter, which is fitted near the nose and mouth area. Sometimes known as “gas masks,” respirators are useful in a variety of situations in which air quality poses a health risk, from furniture refinishing to chemical warfare.

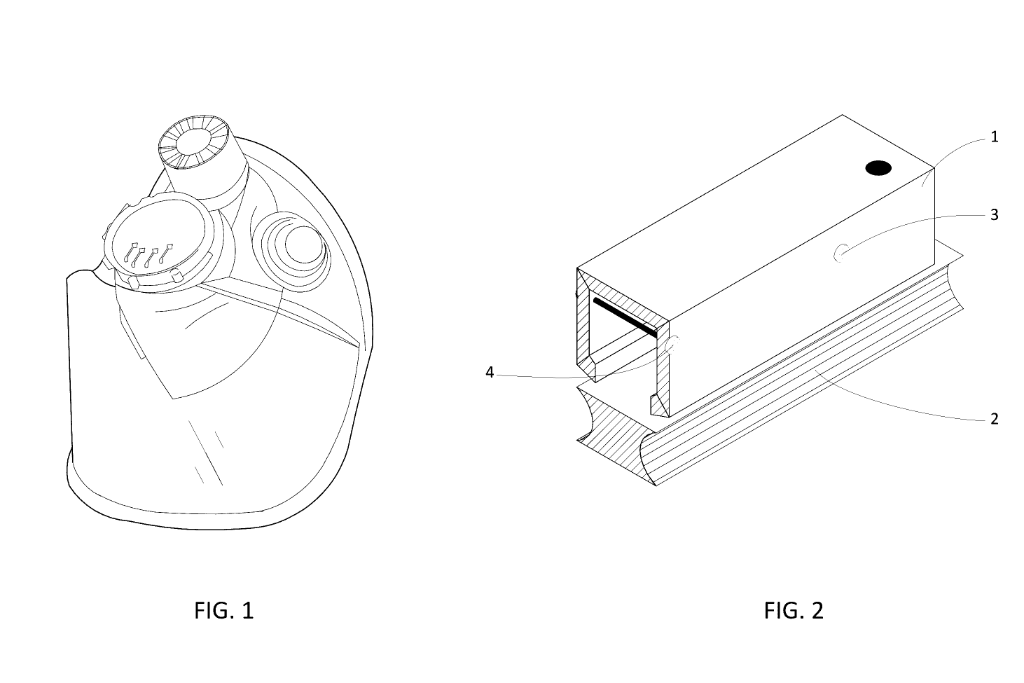

Referring to FIG. 1, there is shown a full face respirator mask, generally designated. Respirator mask is a full face respirator mask that provides coverage of substantially the entire area over a wearer's face, including coverage of the eyes, nose and mouth. Respirator mask includes a clamp 1 and a rail 2. The clamp and rail are picatinny style clamp and rail FIG. 2. A plurality of screws 3 and 4 are used to tightening the clamp to the picatinny rail. By using a picatinny style clamp and rail to join together, the two halves of the lens frame which are holding together the rest of the respirator. The picatinny style rail through which the clamp attaches, will be located near the base where two frames meet and divided by length wise on middle. The clamp being connected on the sides to either half of the respirator by a hinge (like a door hinge) so all one has to do is flip the lock clamp after tightening or loosening the screw on the lock clamp. The design of the invention has a swivel on the picatinny style clamp that is attached to the lens frame. Therefore ending up with no loose pieces of the lens frame assembly. As described above, the functional aspects of the present invention is eliminating the miniscule nut and bolt. The preferred material is used for the invention is plastic and aluminum.

It is to be understood that the above description is intended to be illustrative, and not restrictive. For example, the above-discussed embodiments may be used in combination with each other. Many other embodiments will be apparent to those of skill in the art upon reviewing the above description. It is to be understood that the above description is intended to be illustrative, and not restrictive. For example, the above-discussed embodiments may be used in combination with each other. Many other embodiments will be apparent to those of skill in the art upon reviewing the above description.

Plural instances may be provided for components, operations or structures described herein as a single instance. Finally, boundaries between various components are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

The invention claimed is:

9. A full face respirator comprises:
a clamp;
a rail;
a plurality of screws;
a lens frame; and
a swivel.

10. The full face respirator as in claim 1, wherein said clamp is picatinny style clamp.

11. The full face respirator as in claim 1, wherein said rail is picatinny style rail.

12. The full face respirator as in claim 1, wherein said plurality of screws is used for tightening the clamp to the picatinny rail.

13. The full face respirator as in claim 1, wherein said lens frame is attached to said swivel, that is mounted on half of the said lens frame.

14. The full face respirator as in claim 1, wherein said swivel is connected on the picatinny style clamp that is attached to said lens frame.

15. The full face respirator as in claim 1, wherein said clamp connected on the sides to either half of the respirator by hinge.

16. The full face respirator as in claim 1, wherein said full race respirator is made of plastic and aluminum.
